(19) United States
(12) Patent Application Publication
(10) Pub. No.: US 2009/0292883 A1
(43) Pub. Date: Nov. 26, 2009

(54) Apparatus, Method, and Computer Program Product for Memory Validation Operations in a Memory

(75) Inventor: Rami Arto Koivunen, Turku (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/126,144

(22) Filed: May 23, 2008

(51) Int. Cl. G06F 12/00

(52) U.S. Cl. 711/144; 711/E12.001

(57) ABSTRACT

In accordance with an example embodiment of the present invention, an apparatus, comprising a first memory, wherein the first memory is configured to store data related to a first event, store a memory validation indicator related to a second event, and a second memory, wherein the second memory is configured to store a memory validation indicator related to the first event, wherein the first memory validation is based at least in part on the second memory validation indicator.

### TECHNICAL FIELD

The present application relates generally to memory management.

### BACKGROUND

The modern era of electronic devices has seen a dramatic increase in the number of electronic devices used by individuals. These devices are experiencing an unprecedented growth in consumer demand. Many of these devices utilize electronically programmable memory which may have a reliability lifetime limited by the number of certain operations within the lifetime of the memory. For example, some electronically programmable memory devices become less reliable after performing a certain number of erase operations. The reliability of these devices may be related to the reliability of the programmable memory. For example, in such a device, if at least part of the memory becomes unreliable, the product itself may become unreliable. Many of these devices may utilize a memory validation indicator, for example a dirty bit, to determine, at least in part, if data in a memory is valid.

### SUMMARY

Various aspects of the invention are set out in the claims.

In accordance with an example embodiment of the present invention, an apparatus, comprising a first memory, wherein the first memory is configured to store data related to a first event, store a memory validation indicator related to a second event, and a second memory, wherein the second memory is configured to store a memory validation indicator related to the first event, wherein the first memory validation is based at least in part on the second memory validation indicator.

In accordance with another example embodiment of the present invention, a method, comprising receiving at least one first event related to setting at least one memory validation indicator in a first memory, storing the at least one memory validation indicator in a second memory prior to receiving at least one second event, and setting at least one memory validation indicator in the first memory in relation to receiving the at least one second event.

In accordance with another example embodiment of the present invention, a computer program product comprising a computer-readable medium bearing computer program code embodied therein for use with a computer, the computer program code comprising code for receiving at least one first event related to setting at least one memory validation indicator in a first memory, code for storing the at least one memory validation indicator in a second memory prior to receiving at least one second event, and code for performing the setting at least one memory validation indicator in the first memory in relation to receiving the at least one second event.

In accordance with another example embodiment of the present invention, a computer-readable medium encoded with instructions that, when executed by a computer, perform receiving at least one first event related to setting at least one memory validation indicator in a first memory, storing the at least one memory validation indicator in a second memory prior to receiving at least one second event, and performing the setting at least one memory validation indicator in the first memory in relation to receiving the at least one second event.

### BRIEF DESCRIPTION OF THE DRAWINGS

For a more complete understanding of example embodiments of the present invention, the objects and potential advantages thereof, reference is now made to the following descriptions taken in connection with the accompanying drawings in which:

FIG. 1 is a block diagram of an electronic device according to an example embodiment of the present invention;

FIG. 2 is a block diagram of an example embodiment of a memory validation indicator and related data;

FIG. 3A is a flow diagram of a method for setting a memory validation indicator in accordance with an example embodiment;

FIG. 3B is a flow diagram of a method for verifying a memory validation indicator in accordance with an example embodiment;

FIG. 4 is a block diagram of a memory validation indicator storage according to an example embodiment;

FIG. 5A is a flow diagram of another method for setting a memory validation indicator in accordance with an example embodiment;

FIG. 5B is a flow diagram of a method of reconciling a memory validation indicator in accordance with an example embodiment;

FIG. 6 is a flow diagram of yet another method for setting a memory validation indicator in accordance with an example embodiment.

### DETAILED DESCRIPTION OF THE DRAWINGS

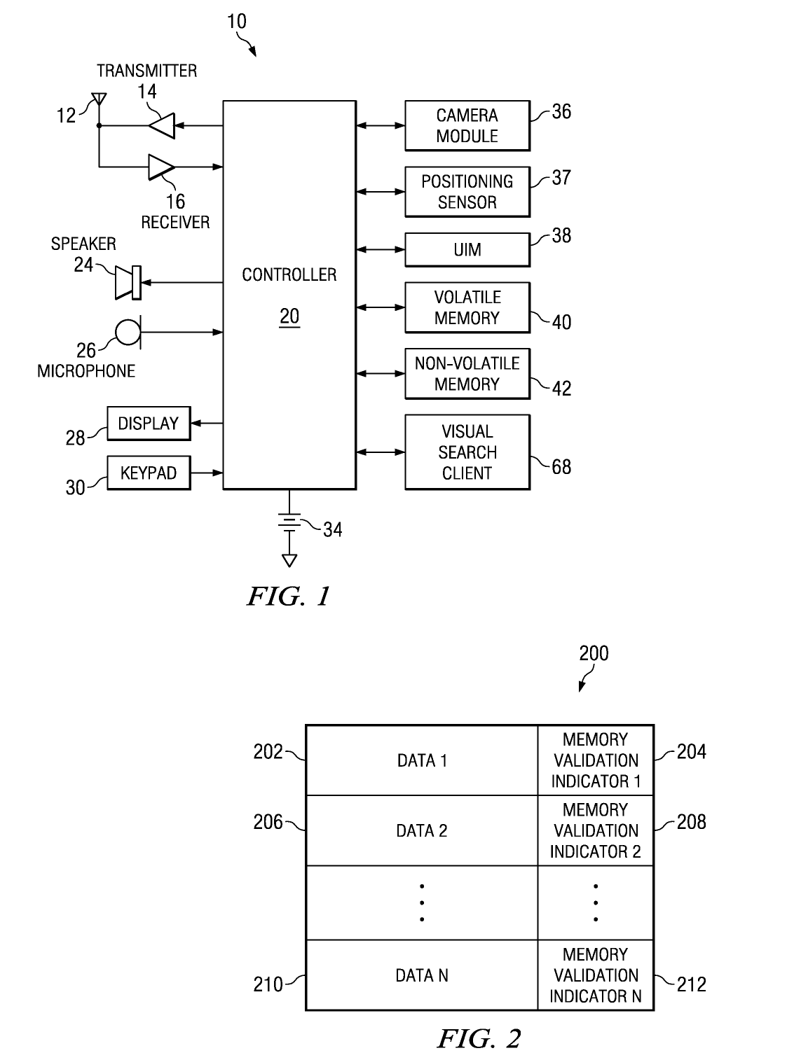

An example embodiment of the present invention and its potential advantages are best understood by referring to FIGS. 1 through 6 of the drawings.

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein.

FIG. 1 is a block diagram of an electronic device, for example, mobile terminal 10, according to an example embodiment of the present invention. It should be understood, however, that a mobile terminal as illustrated and hereinafter described is merely illustrative of an electronic device that would benefit from embodiments of the present invention and, therefore, should not be taken to limit the scope of the present invention. While one embodiment of the mobile terminal 10 is illustrated and will be hereinafter described for purposes of example, other types of electronic devices, such as, but not limited to, portable digital assistants (PDAs), pagers, mobile computers, desktop computers, televisions, gaming devices, laptop computers, cameras, video recorders, GPS devices and other types of electronic systems, may readily employ embodiments of the present invention. Furthermore, devices may readily employ embodiments of the present invention regardless of their intent to provide mobility.

Embodiments of the present invention will be primarily described below in conjunction with mobile communications applications. However, it should be understood that embodiments of the present invention may be utilized in conjunction with a variety of other applications, both in the mobile communications industries and outside of the mobile communications industries.

The mobile terminal 10 comprises an antenna 12 (or multiple antennae) in operable communication with a transmitter 14 and a receiver 16. The mobile terminal 10 further comprises a controller 20 or other processing element that provides signals to and receives signals from the transmitter 14 and receiver 16, respectively. The signals comprise signaling information in accordance with the air interface standard of the applicable cellular system, and also user speech, received data and/or user generated data. In this regard, the mobile terminal 10 may operate with one or more air interface standards, communication protocols, modulation types, and access types. By way of illustration, the mobile terminal 10 may operate in accordance with any of a number of first, second, third and/or fourth-generation communication protocols or the like. For example, the mobile terminal 10 may operate in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols, and/or the like.

It is understood that the controller 20 comprises circuitry desirable for implementing audio and logic functions of the mobile terminal 10. For example, the controller 20 may comprise a digital signal processor device, a microprocessor device, various analog to digital converters, digital to analog converters, and for other support circuits. Control and signal processing functions of the mobile terminal 10 are allocated between these devices according to their respective capabilities. The controller 20 thus may also comprise the functionality to convolutionally encode and interleave message and data prior to modulation and transmission. The controller 20 may additionally comprise an internal voice coder, and may comprise an internal data modem. Further, the controller 20 may comprise functionality to operate one or more software programs, which may be stored in memory. For example, the controller 20 may operate a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP), and/or the like, for example.

The mobile terminal 10 may also comprise a user interface including an output device such as a ringer, a conventional earphone and/or speaker 24, a microphone 26, a display 28, and/or a user input interface, which are coupled to the controller 20. The user input interface, which allows the mobile terminal 10 to receive data, may comprise any of a number of devices allowing the mobile terminal 10 to receive data, such as a keypad 30, a touch display (not shown) or other input device. In embodiments including the keypad 30, the keypad 30 may comprise the conventional numeric (0-9) and related keys (#, *), and other keys used for operating the mobile terminal 10. Alternatively, the keypad 30 may comprise a conventional QWERTY keypad arrangement. The keypad 30 may also comprise various soft keys with associated functions. In addition, or alternatively, the mobile terminal 10 may comprise an interface device such as a joystick or other user input interface. The mobile terminal 10 further comprises a battery 34, such as a vibrating battery pack, for powering various circuits that are required to operate the mobile terminal 10, as well as optionally providing mechanical vibration as a detectable output.

In an example embodiment, the mobile terminal 10 comprises a media capturing element, such as a camera, video and/or audio module, in communication with the controller 20. The media capturing element may be any means for capturing an image, video and/or audio for storage, display or transmission. For example, in an example embodiment in which the media capturing element is a camera module 36, the camera module 36 may comprise a digital camera which may form a digital image file from a captured image. As such, the camera module 36 comprises hardware, such as a lens or other optical component(s), and/or software necessary for creating a digital image file from a captured image. Alternatively, the camera module 36 may comprise only the hardware for viewing an image, while a memory device of the mobile terminal 10 stores instructions for execution by the controller 20 in the form of software for creating a digital image file from a captured image. In an example embodiment, the camera module 36 may further comprise a processing element such as a co-processor which assists the controller 20 in processing image data and an encoder and/or decoder for compressing and/or decompressing image data. The encoder and/or decoder may encode and/or decode according to a standard format, for example, a JPEG standard format.

The mobile terminal 10 may further comprise a user identity module (UIM) 38. The UIM 38 may be a memory device having a built in processor. The UIM 38 may comprise, for example, a subscriber identity module (SIM), a universal integrated circuit card (UICC), a universal subscriber identity module (USIM), a removable user identity module (R-UIM), and/or the like. The UIM 38 may store information elements related to a mobile subscriber. In addition to the UIM 38, the mobile terminal 10 may be equipped with memory. For example, the mobile terminal 10 may comprise volatile memory 40, such as volatile Random Access Memory (RAM) including a cache area for the temporary storage of data. The mobile terminal 10 may also comprise other memory, for example, non-volatile memory 42, which may be embedded and/or may be removable. The non-volatile memory 42 may additionally or alternatively comprise an EEPROM, flash memory or the like, such as that available from the SanDisk Corporation of Sunnyvale, Calif., or Lexar Media Inc. of Fremont, Calif. The memories may store any of a number of pieces of information, and data. The information and data may be used by the mobile terminal 10 to implement the functions of the mobile terminal 10. For example, the memories may comprise an identifier, such as an international mobile equipment identification (IMEI) code, which may uniquely identify the mobile terminal 10.

Although FIG. 1 illustrates an example of a mobile terminal which may utilize embodiments of the present invention, it should be understood that the mobile terminal 10 of FIG. 1 is merely an example device that may utilize embodiments of the present invention. Generally speaking, any device having a processing element for managing memory operations may utilize embodiments of the present invention. In this regard, for example, such a device may also comprise or otherwise be in communication with a memory device. Such a device may comprise some form of user interface. For example, such devices could be, but are not limited to, portable digital assistants (PDAs), pagers, mobile computers, desktop computers, televisions, gaming devices, laptop computers, cameras, video recorders, GPS devices and other types of electronic systems. A processing element such as those described above may be embodied in many ways. For example, the processing element may be embodied as a processor, a coprocessor, a controller or various other processing means or devices including integrated circuits such as, for example, an ASIC (application specific integrated circuit), FPGA (field programmable gate array), and/or the like.

FIG. 2 is a block diagram of an example embodiment of a memory validation indicator and related data. A memory validation indicator may be, for example a memory validation bit, a dirty bit, a clean bit, and/or the like, and related data in a memory, for example memory 42 of FIG. 1. Data 1 (202) is shown with its associated memory validation indicator, for example memory validation indicator 1 (204). It should be understood that it may be desirable to represent a memory validation indicator as a circuit, such as a logic gate, one bit of data, more than one bit of data, and/or the like. In addition, even though the blocks of FIG. 2 relating to data and the related memory validation indicator are illustrated proximately, it may be possible in an embodiment to locate data and the related memory validation indicator without regard to proximity. Data 2 (206) is shown with its associated memory validation indicator, for example memory validation indicator 2 (208). At block 210, data N (210) is shown with its associated memory validation indicator, for example memory validation indicator N (212). It should be understood that the amount of data associated with a memory validation indicator may vary. For example, one example embodiment may relate a memory validation indicator to 4 bytes of data, while another example embodiment may relate a memory validation indicator to 16 bytes of data. It should be further understood that the amount of data associated with a memory validation indicator may vary within a device, over time, and/or the like. For example, in an example embodiment a memory validation indicator may relate to 4 bytes of data for part of the memory, while a memory validation indicator may relate to 16 bytes of data for another part of memory. In another example embodiment, a memory validation indicator may relate to 4 bytes of data at one time, and relate to 8 bytes of data at another time. It should be further understood that data related to a memory validation indicator may comprise contiguous data and/or discontiguous data. For example, a memory validation indicator may relate to data in various memory locations related to each other by a linked list.

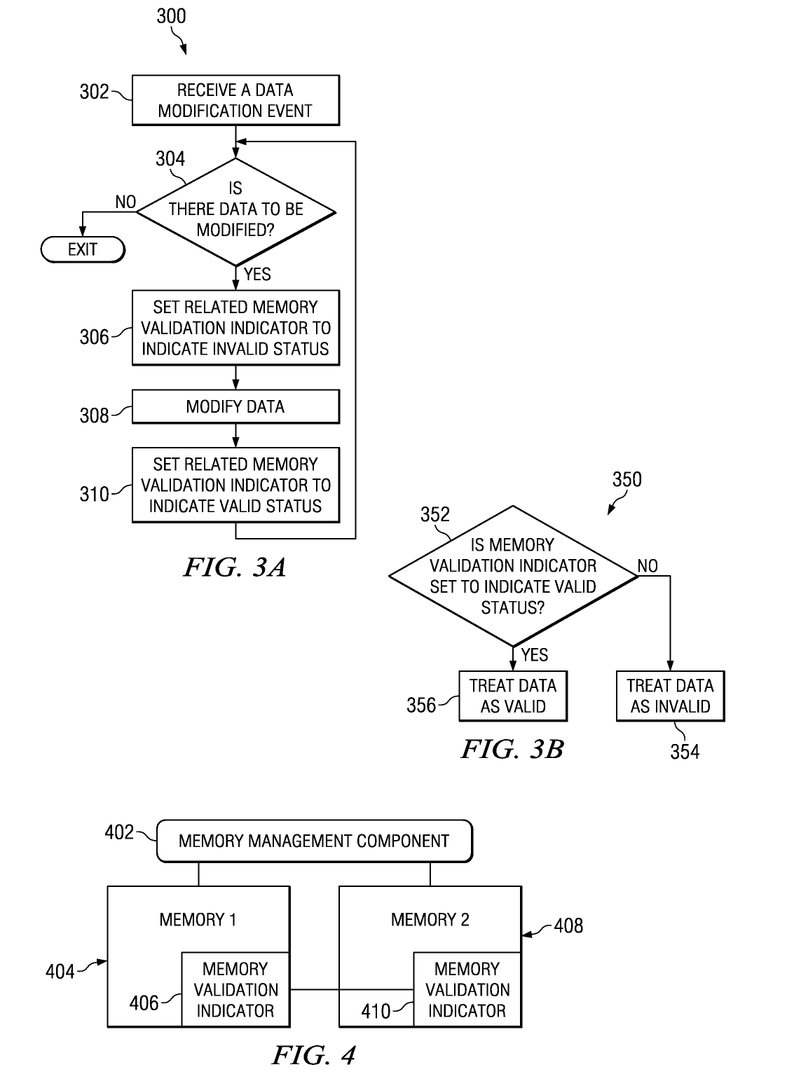

FIG. 3A is a flow diagram of a method for setting a memory validation indicator, for example memory validation indicator (204) of FIG. 2, in accordance with an example embodiment. At block 302, a data modification event is received. The data modification event may comprise a memory operation related to the modification of memory, such as a write operation, an erase operation, and/or the like. At block 304, a check is performed to determine if there is data to be modified. It should be understood that a data modification event may relate to data that may comprise one or more than one part of data which may relate to one or more than one memory validation indicator. For example, if a data modification event relates to data related to more than one memory validation indicator, it may be desirable to perform operations on the data in parts. In such an example, the modification of data in parts may allow processing of multiple memory validation indicators in relation to the processing of the related multiple parts of data.

If at block 304, it is determined that there is no data to be modified, the flow of example 300 may be exited. If at block 304, it is determined that there is data to be modified, at block 306 a memory validation indicator related to at least part of the data may be set to indicate an invalid status. At block 308, at least part of the data may be modified in memory. The modification may comprise a write operation, an erase operation, and/or the like. At block 310, the memory validation indicator related to the data may be set to indicate valid status, and the flow may return to block 304. It can be seen that if block 306 is performed, but block 310 is not performed, that the memory validation indicator may indicate an invalid status. For example, if a memory write operation is being performed at block 308, and a power loss occurs which may not allow block 310 to be performed, the memory validation indicator related to the segment of data may indicate an invalid status.

FIG. 3B is a flow diagram of a method for verifying a memory validation indicator in accordance with an example embodiment. It should be understood, however, that the memory validation indicator verification method of FIG. 3B as illustrated and hereinafter described is merely illustrative of a method for verifying a memory validation indicator which may be employed to validate memory, and therefore, should not be taken to limit the scope of the present invention.

It should be understood that method 350 of FIG. 3B may be utilized to verify one or more than one part of memory. It should be understood that the method 350 may be repeated for a part of and/or the entire memory validation indicators related to a memory. For example, an example embodiment may perform the method 350 for all memory validation indicators in a memory. Although the example of the method 350 relates to processing a single memory validation indicator, more than one memory validation indicator may be processed together. For example, if a segment of memory comprises more than one memory validation indicator, such as a byte comprising 8 memory validation indicators, it may be desirable to process the 8 memory validation indicators together. At block 352 of FIG. 3B, it is determined if a memory validation indicator indicates a valid status. If at block 352, it is determined that the memory validation indicator is set to indicate an invalidstatus, at block 354, the segment of data associated with the memory validation indicator is treated as invalid. This treatment may comprise notifying a user of the device that the data may be invalid, erasing at least part of the data, correcting the data, and/or the like. If at block 352, it is determined that the memory validation indicator is set to indicate a valid status, at block 356 the segment of data associated with the memory validation indicator may be treated as a valid segment of data. For example, there may not be corrective actions associated with the data segment. It should be understood that the method 350 of FIG. 3 may relate to one or more segments of memory.

Verification method 350 may be utilized at one or more various times. For example, it may be desirable to utilize memory verification 350 when power is initially provided. In another example, it may be desirable to utilize memory verification 350 when a user desires memory verification. It should be understood that memory verification 350 may be utilized to verify a part of memory and/or the entire memory.

Memory, for example non-volatile memory 42 of FIG. 1, may exhibit a reliable lifetime limited by a number of one or more types of operations performed on the memory. For example, the storage unit of a type of flash memory may be reliable until 100,000 erases have been performed. It should be understood that there are various factors that may contribute at least in part to the number of operations which may be performed before reliability is noticeably impacted. For example, one flash memory device may be reliable until 2000 erase operations, while another flash memory device may be reliable until 50,000 erase operations. A device, for example mobile terminal 10, may have its reliable lifetime directly related to the reliable lifetime of the non-volatile memory 42. Setting of a memory validation indicator itself may comprise a significant number of operations on the memory throughout the lifetime of a product. Such operations may reduce the reliable lifetime of the memory. Therefore, it may be desirable to reduce the number of memory validation indicator operations.

In order to reduce the number of memory validation indicator operations performed on one memory, for example a second memory, it may be desirable to utilize another memory or type of memory, for example a first memory, which may have its reliability lifetime less impacted by memory operations than a second memory. For example, it may be desirable to utilize a volatile memory, such as RAM (random access memory) to reduce the number of memory validation indicator operations performed on a non-volatile memory such as flash. It may be desirable to store memory validation indicator information in the first memory during frequent memory operations, and to reconcile the memory validation indicator information to the second memory less frequently.

It should be understood that some data may have operations performed on it more often than other data. For example, data associated with file management may be modified with higher frequency than other data. For example, data related to a file allocation table file management method, for example, FAT16, FAT32, exFAT, and/or the like may perform frequent memory operations on data related to file management, such as a root directory, file allocation table, and/or the like. It may be desirable to reduce the number of memory validation indicator operations performed related to the more frequently operated on segments of data. It may be desirable to not reduce the number of memory validation indicator for data that is less frequently operated on.

FIG. 4 is a block diagram of a memory validation indicator storage according to an example embodiment. It should be understood, however, that the memory validation indicator storage embodiment of FIG. 4 as illustrated and hereinafter described is merely illustrative of a memory validation indicator storage embodiment which may be employed to validate memory, and therefore, should not be taken to limit the scope of the present invention.

The example embodiment of FIG. 4 comprises a memory management component 402. It should be understood that the memory management component may comprise a file system, a direct writing interface, a database, and/or the like. In the illustrated embodiment, memory management component 402 is coupled directly or indirectly to one or more memories or parts of memories. Memory 2 (408) relates to a memory that may have its reliability negatively impacted by the number of memory operations performed on it. Memory 1 (404) relates to a memory that may have its reliability less negatively impacted by the number of memory operations performed on it than memory 2 (408). For example, memory 2 (408) may relate to a flash memory, while memory 1 (404) may relate to a RAM memory. In another example, memory 2 (408) may relate to a flash memory having a reliability lifetime of 2,000 erase operations, while memory 1 (404) may relate to a flash memory having a reliability lifetime of 100,000 erase operations. Block 410 relates to a memory validation indicator of the memory 2 (408). Block 406 relates to a memory validation indicator of the memory 1 (404). It should be understood that although there are 2 memory blocks shown in FIG. 4, there may be multiple memory blocks. The memory blocks may have similar and/or varying characteristics. For example, there may be multiple tiers of memory such that there may be yet another memory which may be used to reduce the number of memory validation indicator operations in memory 1 (404). It should be understood that there may be varying number of memory validation indicators between memory 1 (404) and memory 2 (408). For example, memory 2 (408) may comprise at least one memory validation indicator (410), which does not relate to a memory validation indicator (406), of memory 1 (404). In such an example, it may be desirable to relate a memory validation indicator (410), of memory 2 (408), related to a FAT, which may be frequently operated upon, to a memory validation indicator (406), of memory 1 (404), while not relating a memory validation indicator for another segment of data of memory 2 (408), to memory 1 (404). In another example, there may be at least one memory validation indicator (406), of memory 1 (404), which relates to a memory validation indicator related to a memory other than memory 2 (508).

In some cases, it may be desirable to reconcile the memory validation indicator information from memory 1 to memory 2. For example, if power may soon become insufficient for operation, it may be desirable to reconcile the memory validation indicator information from memory 1 to memory 2. It should be understood that there may be various notifications relating to the loss of power. For example, there may be a software notification indicating that power may soon be insufficient for operation. In another example, there may be an electronic signal which may indicate that power may soon be insufficient for operation. It may be desirable to reconcile memory validation indicator information in preparation for a device sleep mode, hibernation mode, and/or the like, for example, a device entering a sleep mode. It may be desirable to reconcile memory validation indicator information periodically, for example every day. It may be desirable to reconcile memory validation indicator information related to an operation, for after performing a de-fragmentation operation.

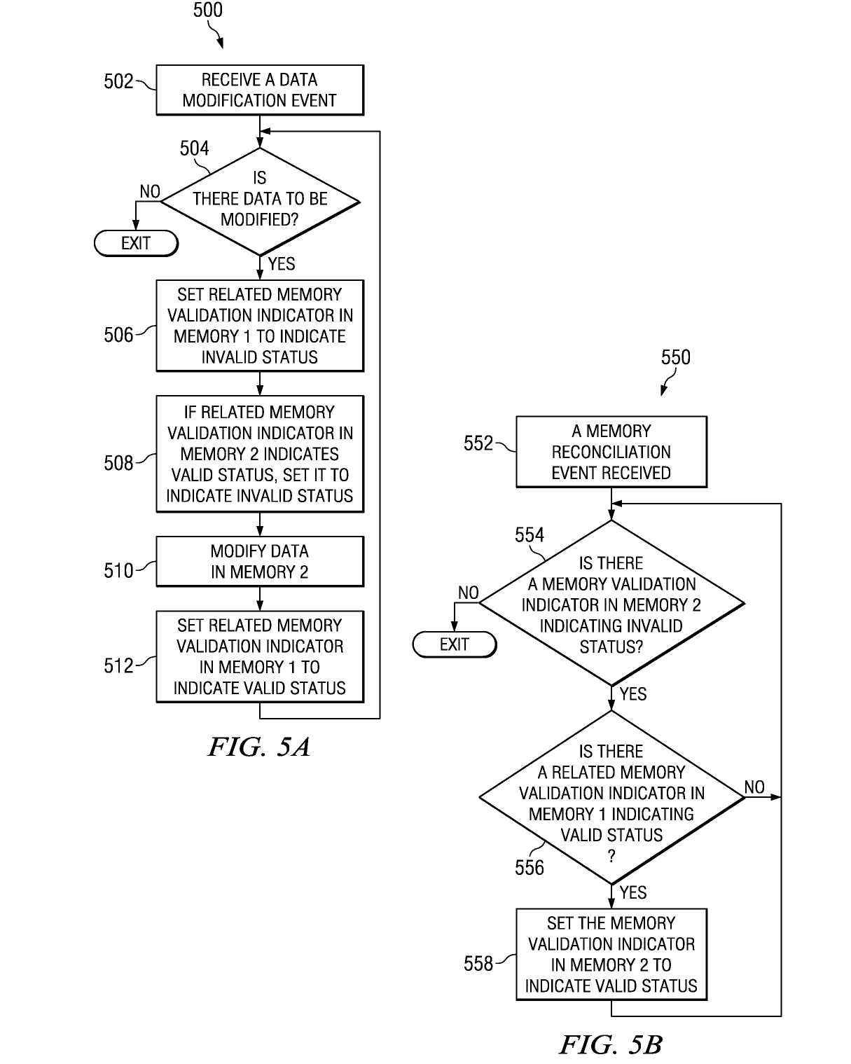

FIG. 5A is a flow diagram of another method for setting a memory validation indicator in accordance with an example embodiment. It should be understood, however, that the method for setting a memory validation indicator of FIG. 5A as illustrated and hereinafter described is merely illustrative of a memory validation indicator setting method which may be employed to validate memory, and therefore, should not be taken to limit the scope of the present invention.

At block 502 of FIG. 5A, a data modification event is received. The data modification event may comprise a memory operation related to the modification of data in memory, such as a write operation, an erase operation, and/or the like. It should be understood that a data modification event may relate to data that may comprise one or more than one part of data which may relate to one or more than one memory validation indicator. For example, if a data modification event relates to data related to more than one memory validation indicator, it may be desirable to perform operations on the data in parts. In such an example, the modification of data in parts may allow processing of multiple memory validation indicators in relation to the processing of the related multiple parts of data. In an example embodiment, at block 504, a check is performed to determine if there is data to be modified. In an example embodiment, if at block 504, it is determined that there is no data to be modified, the flow of example 500 may be exited. If at block 504, it is determined that there is data to be modified, at block 506 a memory validation indicator related to the data may be set in a memory, for example memory 1 (404) of FIG. 4, to indicate an invalid status. At block 508 if a memory validation indicator in a memory, for example memory 2 (408) of FIG. 4, related to the data indicates a valid status, the memory validation indicator of memory 2 may be set to indicate an invalid status. In an example embodiment, the memory validation indicator in memory 2 may be set to indicate an invalid status regardless of current state of the memory validation indicator in memory 1. At block 510, the data may be modified in memory 2. At block 512, a memory validation indicator related to the data may be set to indicate a valid status in memory 1 and the flow may return to block 504.

It can be seen that if block 506 is performed, but block 512 is not performed, that the memory validation indicator in memory 1 may indicate an invalid status. It can be seen that after the flow of example 500 the memory validation indicator of memory 1 indicates a valid status, while the memory validation indicator of memory 2 indicates an invalid status. When performing memory validation indicator verification, for example, memory validation indicator verification method 350 of FIG. 3B, on memory 2, it may be desirable to verify memory 1. Verifying memory 1 may verify a completed data modification which has a memory validation indicator which has not been reconciled. In an example embodiment, after data is modified, it may be desirable to have the associated memory validation indicator of memory 2 indicate an invalid status and the associated memory validation indicator of memory 2 indicate a valid status until the associated memory validation indicator is reconciled. It should be understood that there may be various methods for relating a memory validation indicator in memory 2 to a memory validation indicator in memory 1. For example, there may be a data structure, an address mapping, and/or the like to represent at least one memory validation indicator of memory 2 in memory 1.

FIG. 5B is a flow diagram of a method of reconciling a memory validation indicator in accordance with an example embodiment. It should be understood, however, that the method of reconciling a memory validation indicator of FIG. 5B as illustrated and hereinafter described is merely illustrative of a memory validation indicator reconciliation method which may be employed to reconcile memory, and therefore, should not be taken to limit the scope of the present invention.

At block 552 of FIG. 5B, a memory reconciliation event is received. The event may comprise a software signal, hardware signal, and/or the like. A memory reconciliation event may comprise a power-off notification, a specified operation, a sleep condition, and/or the like. At block 554, it is determined if there is a memory validation indicator in a memory, for example memory 2 (404) of FIG. 4, indicating an invalid status. If, at block 554, it is determined that there is not a memory validation indicator in memory 2 indicating an invalid status, the flow 550 of FIG. 5B may exit. If, at block 554, it is determined that there is a memory validation indicator in memory 2 indicating an invalid status, at block 556 it is determined if there is a related memory validation indicator in memory 1, for example memory 1 (404) of FIG. 4, indicating a valid status. If at block 556, it is determined that there is no related memory validation indicator in memory 1 indicating a valid status, the flow may proceed to block 554. If, at block 556, it is determined that there is a related memory validation indicator in memory 1 indicating a valid status, at block 558 the memory validation indicator in memory 2 is set to indicate a valid status, and the flow may return to block 554. In an example embodiment, if block 554 is reached during the modification of data, for example a data write operation performed by a different process, the determinations of block 554 and of block 556 may be repeated until the memory validation indicator is set upon completion of the modification.

When representing a memory validation indicator related to a memory 2, for example memory 2 (408) of FIG. 4, in a memory 1, for example memory 1, block 404 of FIG. 4, it may be desirable to limit the number of memory validation indicators which may be represented in memory 1. The limitation of the number of memory validation indicators which may be represented in one memory related to memory validation indicators in another memory may be referred to as a memory validation indicator mapping threshold. For example, if a device is capable of writing 512 memory validation indicators between receiving a notification that power will soon be insufficient for operation and the power becoming insufficient for operation, it may be desirable to utilize a memory validation indicator mapping threshold of 512. In this example, the memory validation indicator mapping threshold may facilitate timely memory validation indicator reconciliation in a power-off scenario. It should be understood that there may be various methods for selecting and managing which memory validation indicators to represent in memory 1. Selection criteria may comprise first in first out, frequency of use prioritization, last used first out, and/or the like.

It may be desirable to limit the number of memory validation indicators in a second memory related to memory validation indicators in a first memory. The number limitation may be represented by a memory validation indicator mapping threshold. For example, there may be a time limitation which may allow only a limited number of memory validation indicators to be reconciled, for example as in memory validation indicator reconciliation method 550 of FIG. 5B. In such an example, it may be desirable to have a memory validation indicator mapping threshold set to a number less than the limited number of memory validation indicators which may be reconciled in the limited time.

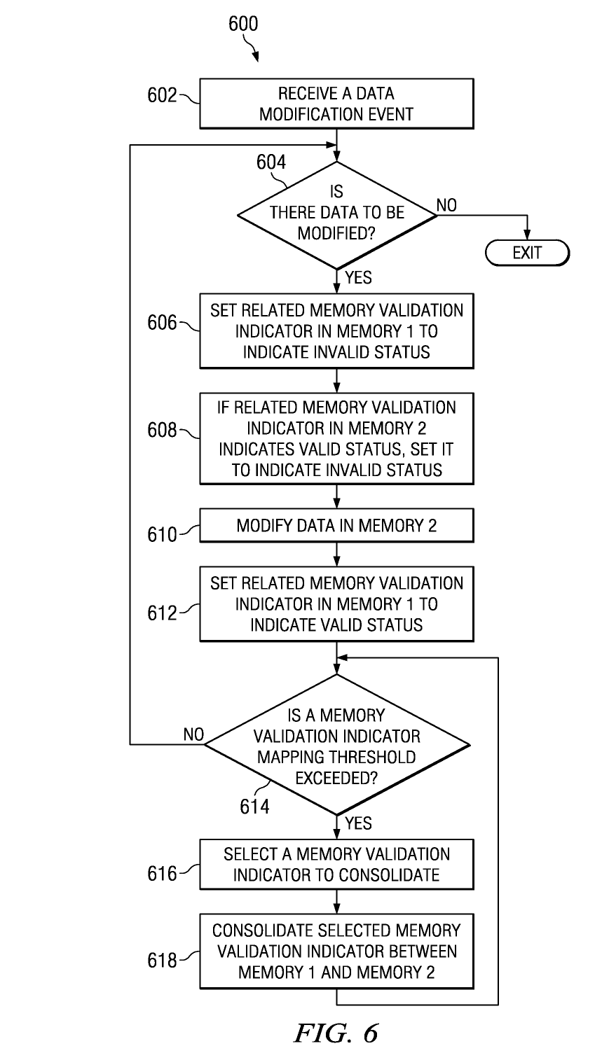

FIG. 6 is a flow diagram of yet another method for setting a memory validation indicator in accordance with an example embodiment. It should be understood, however, that the method for setting a memory validation indicator of FIG. 6 as illustrated and hereinafter described is merely illustrative of a memory validation indicator setting method which may be employed to validate memory, and therefore, should not be taken to limit the scope of the present invention.

At block 602 of FIG. 6, a data modification event is received. The data modification event may comprise a memory operation related to the modification of memory, such as a write operation, an erase operation, and/or the like. It should be understood that a data modification event may relate to data that may comprise one or more than one part of data which may relate to one or more than one memory validation indicator. For example, if a data modification event relates to data related to more than one memory validation indicator, it may be desirable to perform operations on the data in parts. In such an example, the modification of data in parts may allow processing of multiple memory validation indicators in relation to the processing of the related multiple parts of data. At block 604, a check is performed to determine if there is data to be written. If at block 604, it is determined that there is no data to be written, the flow of example 600 may be exited. If at block 604, it is determined that there is data to be written, at block 606 a memory validation indicator related to the data may be set in a memory, for example memory 1 (404) of FIG. 4, to indicate an invalid status. At block 608 if a memory validation indicator related to the data indicates a valid status, the memory validation indicator may be set in a memory, for example memory 2 (408) of FIG. 4, to indicate an invalid status. At block 610, the data may be written in memory 2. At block 612, a memory validation indicator related to the data may be set to indicate a valid status in memory 1.

At block 614, it is determined if a memory validation indicator mapping threshold has been exceeded. If at block 614, it is determined that a memory validation indicator mapping threshold has not been exceeded, the flow may return to block 604. If at block 614, it is determined that a memory validation indicator mapping threshold has been exceeded, a memory validation indicator is selected to reconcile at block 616. It should be understood that there may be various methods for selecting which memory validation indicator to reconcile. Selection criteria may comprise first in first out, frequency of use prioritization, last used first out, and/or the like. At block 618, the selected memory validation indicator is reconciled, and the flow may return to block 614. There are various methods which may comprise the memory validation indicator reconciliation at block 618. For example, memory validation indicator reconciliation may comprise the memory validation indicator reconciliation method 550 of FIG. 5B.

Without in any way limiting the scope, interpretation, or application of the claims appearing below, it is possible that a technical effect of one or more of the example embodiments disclosed herein may be reducing the number of memory operations performed on a memory. Another possible technical effect of one or more of the example embodiments disclosed herein may be improving the reliability lifetime of a memory. Another technical effect of one or more of the example embodiments disclosed herein may be reducing the negative impact on reliability lifetime of memory operations related to frequently accessed memory elements such as elements related to a file allocation table file management method. Another technical effect of one or more example embodiments disclosed herein may be reducing the amount of time to perform memory operations.

Embodiments of the present invention may be implemented in software, hardware, application logic or a combination of software, hardware and application logic. The software, application logic and/or hardware may reside on a memory device, and/or a programmable device. If desired, part of the software, application logic and/or hardware may reside on a memory device and part of the software, application logic and/or hardware may reside on a programmable device. The application logic, software or an instruction set is preferably maintained on any one of various conventional computer-readable media. In the context of this document, a “computer-readable medium” can be any media or means that can contain, store, communicate, propagate or transport the instructions for use by or in connection with an instruction execution system, apparatus, or device.

If desired, the different functions discussed herein may be performed in any order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes exemplifying embodiments of the invention, these descriptions should not be viewed in a limiting sense. Rather, there are several variations and modifications which may be made without departing from the scope of the present invention as defined in the appended claims.

What is claimed is:

1. An apparatus, comprising:
a first memory, wherein said first memory is configured to store data related to a first event and store a memory validation indicator related to a second event; and
a second memory, wherein said second memory is configured to store a memory validation indicator related to said first event, wherein said first memory validation is based at least in part on said second memory validation indicator.

2. The apparatus of claim 1, wherein said first memory comprises non-volatile memory.

3. The apparatus of claim 1, wherein said second memory comprises volatile memory.

4. The apparatus of claim 1, wherein said second event relates at least in part to a power-off event.

5. The apparatus of claim 1, wherein said second event relates at least in part to a quantity of at least one memory validation indicators stored in said second memory.

6. The apparatus of claim 1, wherein said at least one memory validation indicator relates at least in part to file allocation table data.

7. The apparatus of claim 1, wherein said processor is further configured to write data related to but not comprising said at least one memory validation indicator to said first memory upon receiving said first event

8. The apparatus of claim 1, wherein said second event relates at least in part to a sleep mode.

9. A method, comprising:
receiving at least one first event related to setting at least one memory validation indicator in a first memory;
storing said at least one memory validation indicator in a second memory prior to receiving at least one second event; and
setting at least one memory validation indicator in said first memory in relation to receiving said at least one second event.

10. The method of claim 9, wherein said first memory comprises non-volatile memory.

11. The method of claim 9, wherein said second memory comprises volatile memory.

12. The method of claim 9, wherein said second event relates at least in part to a power-off event.

13. The method of claim 9, wherein said second event relates at least in part to a quantity of at least one memory validation indicators stored in said second memory.

14. The method of claim 9, wherein said at least one memory validation indicator relates at least in part to file allocation table data.

15. The method of claim 9, further comprising writing data related to but not comprising said at least one memory validation indicator to said first memory upon receiving said first event.

16. The method of claim 9, wherein said second event relates at least in part to a sleep mode.

17. The method of claim 9, further comprising setting said at least one memory validation indicator in said first memory to indicate a status of invalid prior to receiving said second event.

18. The method of claim 9, wherein storing said at least one memory validation indicator in a second memory prior to receiving at least one second event comprises setting comprises setting said at least one memory validation indicator to indicate a status of invalid.

19. The method of claim 9, wherein storing said at least one memory validation indicator in a second memory prior to receiving at least one second event comprises setting comprises setting said at least one memory validation indicator to indicate a status of valid.

20. The method of claim 9, wherein storing said at least one memory validation indicator in a second memory prior to receiving at least one second event relates to modifying data related to said memory validation indicator in said first memory.

21. A computer program product comprising a computer-readable medium bearing computer program code embodied therein for use with a computer, the computer program code comprising:
code for receiving at least one first event related to setting at least one memory validation indicator in a first memory;
code for storing said at least one memory validation indicator in a second memory prior to receiving at least one second event; and
code for performing said setting at least one memory validation indicator in said first memory in relation to receiving said at least one second event.

22. The computer program product of claim 21, wherein said first memory comprises non-volatile memory.

23. The computer program product of claim 21, wherein said second memory comprises volatile memory.

24. The computer program product of claim 21, wherein said second event relates at least in part to a power-off event.

25. The computer program product of claim 21, wherein said second event relates at least in part to a quantity of at least one memory validation indicators stored in said second memory.

26. The computer program product of claim 21, wherein said at least one memory validation indicator relates at least in part to file allocation table data.

27. The computer program product of claim 21, further comprising code for writing data related to but not comprising said at least one memory validation indicator to said first memory upon receiving said first event.

28. The computer program product of claim 21, wherein said second event relates at least in part to a sleep mode.

29. A computer-readable medium encoded with instructions that, when executed by a computer, perform:
receiving at least one first event related to setting at least one memory validation indicator in a first memory;
storing said at least one memory validation indicator in a second memory prior to receiving at least one second event; and
performing said setting at least one memory validation indicator in said first memory in relation to receiving said at least one second event.
